(19) United States
(12) Patent Application Publication
(10) Pub. No.: US 2018/0307193 A1
(43) Pub. Date: Oct. 25, 2018

(54) AUTOMATED CONTROL OF PROCESSES

(71) Applicant: WONDERLOGIX LTD., Kiryat Ata (IL)

(72) Inventors: Dror ROTH, Ramot Meir (IL); Amir KAUFMAN, Kiryat Tivon (IL)

(73) Assignee: Wonderlogix Ltd., Kiryat Ata (IL)

(21) Appl. No.: 15/738,126

(22) PCT Filed: Jun. 21, 2016
(86) PCT No.: PCT/IL2016/050659

§ 371 Date: Dec. 20, 2017

(30) Foreign Application Priority Data
Jun. 22, 2015 (IL) 239575

(51) Int. Cl. G05B 19/05

(52) U.S. Cl. CPC G05B 19/05; G05B 2219/163

(57) ABSTRACT

A method of generating a neutral control model to be used for programming production facility controllers, the method comprising: defining a plurality of nodes; adding to each node of the plurality of nodes at least one attribute; building a plurality of sentences, wherein each sentence is bound for linking at least one attribute of the at least one attribute to at least one another attribute of the at least one attribute; wherein terms of the sentence are selected from a group comprising of: at least one node of the plurality of nodes; the at least one attribute; at least one natural language word; and a combination thereof; editing by a processor, each sentence of the plurality of sentences, to comply with syntax rules of the neutral control model; and converting the plurality of logic sentences into a controller code.

### FIELD

The present invention relates to automated control of processes.

### BACKGROUND

Control systems are automated systems that manage the operation of physical systems such as industrial facilities, smart homes and machines. These control systems receive inputs from the physical systems; run some predefined calculations on the data extracted from the inputs, and send signals back to the physical equipment in order to perform a control action on the equipment. For example, the controller of an air conditioner receives as an input the ambient temperature, runs a calculation that determines if this temperature is greater than a certain set point, and if true sends an output to the cooling unit to start.

Control systems can be implemented using electrical relays, but nowadays almost every control system is implemented using a special computer (hereby, “a controller”), that can be programmed to perform the desired control action (the required calculations on the input signals that modify the output signals).

U.S. Pat. No. 5,812,394 describes an object-oriented development system for developing control schemes for facilities, that includes a device diagramming component for describing a physical description of a facility and a logical definition of a control scheme for the facility. The device diagramming component includes a mode for selecting device symbols representative of equipment or control functions used in facilities. The device symbols are selected from an object-oriented repository containing a plurality of device symbols and device objects. Certain types of device symbols relate to device objects containing logical instructions and configuration information relating to the represented equipment or control functions. The device diagramming component also includes a mode for interrelating in a graphical manner the selected device symbols and their corresponding device objects into a device diagram representing the physical description of the facility and the logical definition of the control scheme for the facility. A device logic developing component defines the logical instructions of the device objects relating to the equipment or control functions. Thus, the development system is intended to integrate in a graphical format the physical description of the facility with the logical instructions which define the control scheme for the facility.

U.S. Pat. No. 6,442,441 describes a method of automatically generating and verifying programmable logic controller (PLC) code. The method includes the steps of constructing a neutral control model file, determining whether the neutral control model file is correct, generating PLC code if the neutral control model file is correct, verifying whether the PLC code is correct, and using the PLC code to build a tool.

Although automated control systems virtually control production on an enormous scale and despite improvements such as described in U.S. Pat. No. 5,812,394 and U.S. Pat. No. 6,442,441, these systems remain too often of poor quality, which can result in unnecessary losses, damages and risks.

Possible reasons for the poor quality may include:

Vague and inadequate definition of the software requirements. These definitions lack any standard and are usually partial and inaccurate;

Inadequate skills of the control system's programmers

Primitive programming languages that make following software engineering practices and methodologies difficult.

Over the past few years, the inventors have personally witnessed two severe failures, out of about twenty facilities, that were the result of system bugs. One of these failures led to $200,000 worth of damage, as well as a four-month work stoppage that resulted in lost revenue totaling $3 million.

Additionally, the inventors have encountered many cases where manual mode was set by the operators due to improper automated functionality. Manual operation, which disables the control system's ability to continuously maximize production led to revenue loss.

Control systems are becoming bigger and more complex, as is their software. Without the support of established methods and automated aids, it will soon become impossible to produce reliable automated systems at a reasonable cost.

One goal is to enable users such as process engineers to completely set up the required operation of an industrial facility in an intuitive, flexible, yet structured manner.

Another is to enable a user to easily go through the familiar steps of object-oriented design.

Yet another is to allow users to simulate and test the process before it is fully operated, a fundamental need that is often left inadequately addressed if at all.

### SUMMARY

According to a first aspect, a method of generating a neutral control model to be used for programming production facility controllers is provided. The method comprising:
defining a plurality of nodes;
adding to each node of the plurality of nodes at least one attribute;
building a plurality of sentences, wherein each sentence of the plurality of sentences is bound for linking at least one attribute of the at least one attribute to at least one another attribute of the at least one attribute; wherein terms of the sentence are selected from a group comprising of: at least one node of the plurality of nodes; the at least one attribute; at least one natural language word; and a combination thereof;
editing by a processor, each sentence of the plurality of sentences, to comply with syntax rules of the neutral control model; and
converting the plurality of logic sentences into a controller code.

In accordance with another embodiment, the neutral control model is formed in a hierarchical structure tree, and wherein each node of the plurality of nodes is assigned a hierarchical level in the structure tree.

In accordance with another embodiment, the at least one attribute is selected from types comprising of: Inputs; outputs; properties; parameters; and a combination thereof.

In accordance with another embodiment, the at least one natural language word is selected from a plurality of lists of words, wherein each of the at least one attribute is assigned at least one list of words from the plurality of lists of words.

In accordance with another embodiment, the building further comprising automatically prompting at least one list of words from the plurality of lists of words assigned to the at least one attribute.

In accordance with another embodiment, the method further comprising: deducting the type of the at least one attribute comprised in the each sentence of the plurality of sentences according to the at least one word in the sentence adjacent to the attribute; wherein a sentence undergo said deducting the type is a deduced type; and selecting hardware configured to support the deduced type of the at least one attribute.

In accordance with another embodiment, the method further comprising reducing the length of the prompted list of words while building the each sentence of the plurality of sentences, according to the deduced type of the at least one attribute comprised in the each sentence of the plurality of sentences.

In accordance with another embodiment, the method further comprising: validating an existing type of each of the at least one attribute comprised in the each sentence of the plurality of sentences by comparing the existing type to the deduced type; and alerting if the comparing result indicates a mismatch of types.

In accordance with another embodiment, a portion of the nodes is selected from a group comprising of: at least one input having a value set by at least one production facility; at least one output having a value transferred to one of the at least one production facility; a combination thereof; and wherein the method further comprises linking of said inputs to said outputs, by defining how the value of each said linked input is affected by the value of said linked outputs.

In accordance with another embodiment, the building further comprises adding a user chosen word to the prompted at least one list of words.

In accordance with another embodiment, a portion of the words of the list of words from the plurality of lists of words have similar logical meaning.

In accordance with another embodiment, a computerized device in which the controller code is ported to is configured to allow debugging the controller code prior to operating the production facility.

In accordance with another embodiment, each of the at least one attribute comprises a value, and wherein the debugging comprises:
setting predetermined values to at least one attributes of a first portion of the plurality of nodes;
obtaining values of at least one attributes of a second portion of the plurality of nodes;
comparing expected values of at least one attributes of a second portion of the plurality of nodes; with obtained values of at least one attributes of a second portion of the plurality of nodes; and
outputting an alert in case of a mismatch between the expected and obtained values.

In accordance with another embodiment, the method further comprises:
selecting a first production facility;
selecting a first sentence associated with the first production facility;
selecting a second production facility; and
building a second sentence based on the selected first sentence adapted to the second production facility and associating the second sentence with the selected second facility.

In accordance with another embodiment, the first sentence is associated with a syntax rules, and wherein the method further comprises automatically verifying that the second sentence complies with the syntax rules of the matching first sentence.

In accordance with another embodiment, the plurality of sentences is understandable by a human reader and is unambiguously convertible to controller code.

In accordance with another embodiment, the method further comprising automatically checking that each sentence of the plurality of sentences is associated with an attribute, and wherein the each sentence completely defines only the value of the attribute.

In accordance with another embodiment, the method further comprising automatic supplying of complementary sentences; and eliminating redundant sentences to each sentence of the plurality of sentences associated with the at least one attribute, thereby completely defining a value of the attribute.

In accordance with another embodiment, the method further comprising:
providing a plurality of labels;
labeling with at least one distinctive label from the plurality of labels each of a first portion of the plurality of nodes and each of a second portion of attributes of the plurality of nodes, wherein the nodes of the first portion and the attributes of the second portion have common characteristics, and
displaying a list of nodes and attributes labeled by the at least one distinctive label, and/or not labeled by a portion of the plurality of labels, excluding the at least one distinctive label.

There is also provided in accordance with another aspect and embodiment, a method for defining relations between a plurality of objects representing a controlled system. The method comprising:
providing a hierarchical structure of the plurality of objects;
providing a name and interface signals for at least one of the plurality of objects;
associating each of the plurality of objects with a portion of other objects to create groups of objects;
providing a partial formal grammar, comprising a set of rules to define possible relations among objects in any group, wherein the relations express exchange and manipulation of interface signals among the objects in the group over time;
for each group, completing the partial formal grammar by adding rules that allow derivation of the objects in the group and their interface signals to create a formal grammar which defines the possible relations among objects in the group;
constructing a textual sentence for each interface signal of the at least one object in each group, wherein the textual sentence is valid according to the formal grammar;
constructing additional sentences until the value of each interface signal is completely defined at any time; and
automatically converting the hierarchical structure and the textual sentences to code, loaded into a computerized device that is wired to receive at least one input from and/or deliver at least one output to the controlled system.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the specification, including definitions, will control. In addition, the materials, methods, and examples are illustrative only and not intended to be limiting.

### BRIEF DESCRIPTION OF THE DRAWINGS

Embodiments are herein described, by way of example only, with reference to the accompanying drawings. With specific reference now to the drawings in detail, it is stressed that the particulars shown are by way of example and for purposes of illustrative discussion of the preferred embodiments, and are presented in the cause of providing what is believed to be the most useful and readily understood description of the principles and conceptual aspects of the embodiments. In this regard, no attempt is made to show structural details in more detail than is necessary for a fundamental understanding of the invention, the description taken with the drawings making apparent to those skilled in the art how the several forms of the invention may be embodied in practice.

In the drawings:

FIG. 1 schematically illustrates an example of the flow of data through tree nodes in accordance to a preferred embodiment.

FIG. 2 shows an example of a screen shot from a display on a graphical interface during logic-sentence building according to preferred embodiment.

### DESCRIPTION OF EMBODIMENTS

Before explaining at least one embodiment in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting. For clarity, non-essential elements were omitted from some of the drawings.

### 1. Introduction

The process setup and methods described below enable a process engineer, to design the control of production facilities in a systematic and precise manner. The design process ends with obtaining a controller code which allows direct operation of the production facilities, by automatic conversion of the design to controller code. This in contrary to current work flow, in which a third party is required for interpreting the design and manually programming the controller.

According to one aspect, a process-construction method is provided that comprises creating universal automated definitions of control systems in a production process, and allowing unambiguous conversion of the definitions into controller code, typically PLC (Programmable Logic Controller) code. The code is loaded into a computerized device that is configured to receive inputs from and deliver outputs to the production facilities of the process.

By the term “universal” is meant that the definitions are not limited to any particular computerized platform, yet the definitions are stored in electronic or magnetic storage media and readily accessible for conversion into the controller code.

By “automated”, as will be further explained in detail below, the definitions are dynamically built by a computerized system. The dynamic building is based on definitional data previously stored in the system where the building is being performed.

By “production facility” is meant any process hardware, for example a valve, a sensor, and a production line.

The term “production” is to be broadly interpreted as any technological process.

According to another aspect a system is provided that is configured to allow controlling a production facility based on universal automated definitions of control systems.

It is known that controller codes are generally written for a particular process only after the designs of the process are completed and the process has been defined. In fact, the controller code is usually not tried out, i.e., debugged, until the physical components of the process are built and connected to a controller upon which the code runs.

The creation of the controller code is commonly mostly a manual programming task with any automation of the code generation limited to “cutting and pasting”, previously written blocks of code that were applied to similar production facility components.

U.S. Pat. No. 6,442,441 purported to create the programmable logic controller code such that it could be tied directly with manufacturing process planning and to have a process with the ability to automatically generate and verify manufacturing programmable logic controller code. U.S. Pat. No. 6,442,441 also purported to provide a process that will enable generation and analytical verification of programmable logic controller code prior to physical construction of the process (hard tool building).

Accordingly, U.S. Pat. No. 6,442,441 provided a method of automatically generating and verifying programmable logic controller code that includes the steps of constructing a neutral control model file, determining whether the neutral control model file is correct and generating programmable logic controller (PLC) code if the neutral control model file is correct. The method also includes the steps of verifying whether the PLC code is correct and using the PLC code to build a tool if the PLC code is correct.

The neutral control model file referred to in U.S. Pat. No. 6,442,441 is a neutral file that contains a definition of a “control model”. In general, a model is typically some representation of critical elements of a real entity. This term “neutral” is considered meaningful in that the control file used in this process is not specific to any one PLC hardware platform nor is it specific to any one process planning system. For example, in constructing a vehicle body of a motor vehicle, the control model would have individual events that described when the conditions were correct for a clamp to open or close. The control model information from the neutral control model file is purported to be readily passed from one manufacturing facility to another.

In contrast, amongst other aspects, the present invention expands the automatic generation to an earlier stage in the method, to the construction of the so-called neutral file, as will be further described below.

According to yet another aspect, a method is provided that comprises building logic sentences for control of a production facility. These logic sentences are sentences in human language, which can be unambiguously converted into controller code, as will be further described below. Each sentence is associated with a production facility. Again, the facility may be a simple element such as a valve, or a more complex component such as a production line

The sentences are composed of terms that are selected from a computer memory repository, e.g. a database. The terms are arranged in the repository in data structures such as arrays, wherein each array may contain alternative terms, i.e. a user can select a term that seems to the user most suitable for the context in which the term is used in the sentence, but when the sentences are translated into controller code the various alternative terms in the array have the same value.

In some preferred embodiments the arrays are dynamic in size such that additional terms may be added to the array. Thus a user may add and use personally preferred terms that are stored in such array and the user-added term may later be selectable in building the rest of the sentence(s).

A user that defines the control of a facility typically performs the following:

1.1 Defining the controlled facility.

1.2 Assigning facilities as children of the controlled facility; further assigning facilities as children of each child of the controlled facility and so forth, to construct a hierarchical structure that will eventually represent the whole controlled facility. A facility may be referred to as a “parent” of its children. The hierarchical structure is constructed to reflect the physical structure of the facilities and to support the object-oriented design principle of Modularity. Furthermore, according to the principles of Encapsulation and Information Hiding, the construction is gradual, every time on a specific “scope of work” which is a facility (“parent”) and its direct children.

Each child is a “black box” for its parent. It may receive signals from its parent and siblings (other children of the same parent), and may report some signals to its surroundings (its parent and siblings) but will limit the access to its internal data, including its children.

1.3 Defining the interface of each facility with its surroundings (its parent and siblings) by adding inputs and outputs. Note that although a facility with no interface signals may exist, it is an unusual situation, since there is no way for other facilities to interact with this facility. Additionally, adding internal properties and parameters to the facility.

Inputs, outputs, properties and parameters are called “attributes”, wherein the value of inputs, outputs and properties can be modified as a result of calculations based on the value of other attributes, further described below. The value of Parameters can be changed by a human user only, rather than a result of some calculation. Attributes can have a type, wherein inputs and parameters can have the following types: Boolean or analog. Properties and outputs can have the following types: Boolean, analog, timer/counter and states.

1.4 Defining for each attribute its type based on its required behavior. For instance, if the attribute is designed to be turned on or off—it is a Boolean attribute. If this attribute is designed to be equal to the value of another analog attribute multiplied by 2—it is an analog attribute. Since the type of an attribute can be automatically deduced in a later stage (see section 2.2), it may be left undefined.

1.5 Based on the defined attribute type, defining its logic. “Logic” is a collection of one or more sentences, which describe the way to set the value of an attribute based on the current values of other attributes. The logic of the inputs of a child is defined, within its parent. This logic can involve inputs, properties and parameters of the parent, and outputs of the child's siblings. The logic of the properties or outputs of a facility is defined within the facility. This logic can involve inputs, properties and parameters of the facility, and outputs of the facility's children. See more about constructing logic sentences at the logic editing section below.

1.6 Continue defining logic for all attributes. Again, it is worth noting that although an attribute with no logic may exist, it is an unusual situation, since the value of the attribute is left undefined. An exceptional situation occurs for outputs of facilities which represent third party's facilities. The latter are provided as closed systems, therefore their logic is defined by the provider of these systems. From the point of view of the user who performs these steps, the logic of said outputs is defined as “set by others”.

The following sections describe in further detail selected features related to the invention.

### 2. Logic Editing—Building Logic Sentences

In order to build logic sentences which define the possible relations between objects, a “formal grammar” (a term used in Linguistics and Computer Science) defining them is constructed.

First, a partial formal grammar is defined. This grammar is partial, since it lacks the production rules that derive specific nodes and attributes. For example, it will lack a production rule that specifies how to substitute the symbol “child” to the name of a specific child, such as: child=>[“pump 1”|“pump 2” ], where child is a non-terminal symbol (i.e. a symbol to be substituted) and “pump 1” and “pump 2” are terminal symbols (i.e. words in the constructed sentence).

Second, for each scope of work, that is, a certain facility and its direct children, generate complete formal grammar by adding the production rules the partial grammar lacks. This formal grammar is used to allow the user to interactively construct any valid sentence, as detailed below.

Different production rules should be defined for inputs and for output/properties, since different attributes can be involved in them (as described in item 1.5 above).

Additionally, different production rules should be defined for each type of attribute:

Boolean attributes can be set or cleared when a triggering event happens.

Analog attributes can be made equal to another analog attribute or be scaled from it when a triggering event happens.

Timer can start counting time or reset its counting when a triggering event happens.

Counter can count events or reset its counting when a triggering event happens.

A triggering event may result from an evaluation of the state of one or more attributes, and it has a different form for each attribute type:

Boolean attribute: check if it is true or false.

Analog attribute: check if it is greater than or less than another analog value.

Timer/Counter: check if it is greater than or less than another analogvalue, or if it is counting or has reached a preset value.

In some cases, it is useful to define a state machine for a certain facility. The facility is found in one of the defined states at any given moment, and may change state only through defined transitions. The condition for each transition is defined in the same manner a triggering event is defined in the logic of an attribute. The current state can be used for triggering other events, as explained in item 2 below.

When defining this formal grammar, it is important to know how to implement every derived sentence within the control system, whether the control system is built using electrical relays or a programmed controller (for instance—a PLC in industrial facilities or a micro controller used in smart homes).

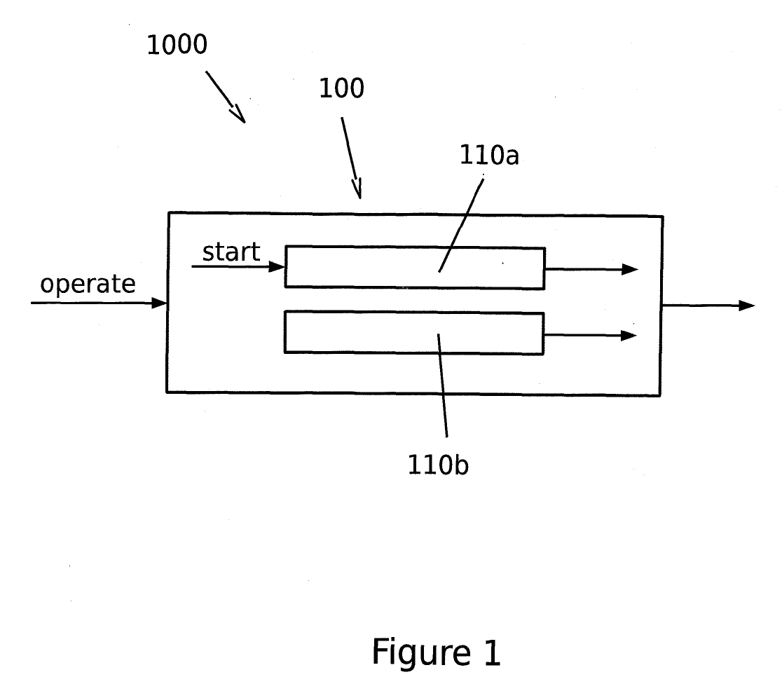

FIG. 1 schematically illustrates an example of the flow of data through the tree nodes.

The system 1000 demonstrates logical sentence evaluation. The system 1000 comprises a Pumping Unit 100 with a Boolean input Operate. The Pumping Unit 100 has two children 110a and 110b, one of them 110a is Pump, with a Boolean input Start. The Pumping Unit 100 and its children 110a and 110b also have outputs, but they are irrelevant for the example.

The logic sentence which defines the Start input to the pump 110a is as follows:

“Start Pump only while Pumping Unit is requested to Operate”.

When this sentence is evaluated, the state of the Boolean input Operate is examined. If it is True (On), the input Start is set. If it is False (Off), the input Start is cleared.

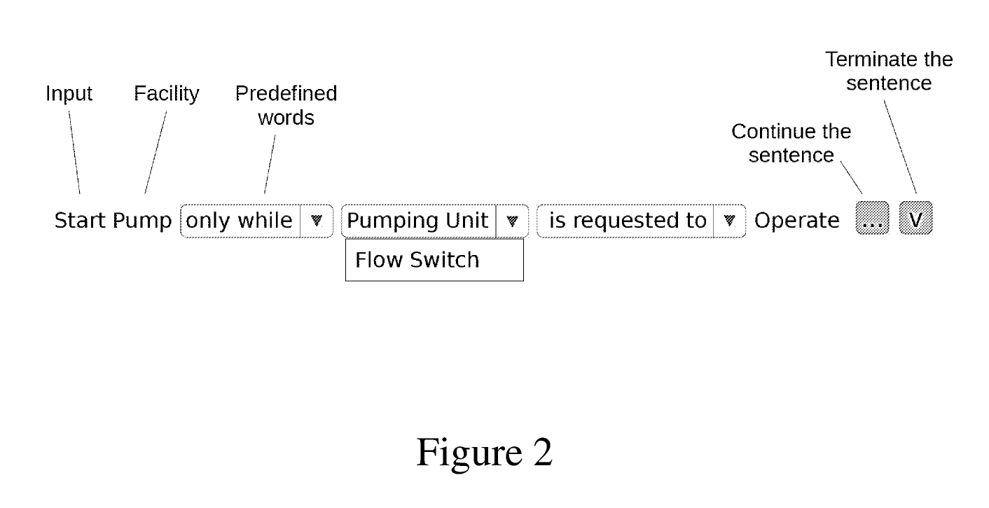

FIG. 2 shows an example of a screen shot from a display on a graphical interface during logic-sentence building. When the user wishes to add logic to a property or output of a certain facility or to an input of a child of the certain facility, a sentence is generated dynamically, comprising objects in the relevant “scope of work”, that is, the certain facility and its children. By selecting names of desired components (facilities and attributes) and connecting-words the sentence is formed to represent the desired logic. The resulting sentence is understood both by the computerized control system and the human reader.

Similar to Java programming language which can run on many operating systems, users can design their control systems independently of the hardware they are going to use eventually. This separation gives the designers the ability to fairly easily shift their design to different hardware.

A code generator converts the neutral models created using the methods described above to controller code in an accurate and predetermined way. The process engineer who designed the logic of the facility's operation can now be sure that the controller code matches his definitions precisely, unlike the current situation, in which the code is dependent on the person who has been chosen to program the controller hardware. This is highly significant in the lifetime of the facility: commissioning is considerably shortened, damage to equipment is minimized and productivity is increased. Future extension of the facility is easily made, as are its modification, duplication or refurbishment.

Some embodiments comprise one or more of the following features:

2.1 Performing logic completeness verification: the logic of each attribute should define the value of the attribute at any time. For example, for “latched” actions, which are triggered and held even if the trigger is no longer true, complete logic includes providing triggers for the “latch” and “unlatch” actions and, defining which of the triggers is “stronger”, in case they are both True. In this example, the “latch-unlatch” actions are represented in the sentence by the words “from the moment”. A completely defined logic thus includes: “from the moment” sentence, complementary “from the moment” sentence and a resolver, a sentence which defines which action to perform in case the two actions are triggered simultaneously.

The embodiment further comprises a validation step, which includes checking the completeness of the sentence(s), and if needed popping a complementary sentence(s) and/or marking redundant sentences that should be deleted. More generally, a “completely defined” logic is logic constructed of one or more sentences, which together define the value of a certain attribute, and that attribute only, at any time. In other words, when this logic is converted to controller code and run by the controller, the latter can determine the value of the attribute to which the logic is associated at any time.

2.2 Type inferring (from logic): The attributes in the model may initially be created without an associated type (Boolean, analog, counter/timer or states). However, when an attribute is used in a sentence, its type is inferred according to words adjacent to it in the sentence. For example: “set attribute . . . ” infers as Boolean, “check if attribute is greater than . . . ” infers as analog, and “attribute counts how many times . . . infers as counter.

In certain cases, conflicting types may be deduced for an attribute. For example, an attribute may be referred to in the logic of two other attributes, in the first as a Boolean and in the second as an analog. In these cases the user will be alerted.

The type of an attribute, if it is received from or send to the field, will determine which hardware is appropriate for it—discrete I/O hardware (typically 0/24 VDC) for Boolean type or analog I/O hardware, (typically 4-20 mA) for analog type.

2.3 Reducing options for additional sentences following type inference: As described in 2.2 above, the use of attributes in sentences may determine their type. Following such type inference, when an additional sentence which involves the same attribute is constructed, the available number of options to select from may narrow down, to fit the already known type of the attribute. This characteristic helps the construction to be faster and easier as logic is defined to more and more attributes in the model.

2.4 Verifying and converting physical units (mm, kg, and seconds). Checking that mathematical operations on variables are consistent in respect to the physical units of the operands, and recognizing conversion rules of units (e.g. force divided by area equals pressure).

2.5 Duplicating logic: in some cases first process facilities are provided, and first logic sentences are provided as well. Each of the first facilities is associated with at least one of the first sentences. In addition, second process facilities are provided which are initially unassociated with sentences. Thus some process construction method embodiments comprise:
a) selecting a first facility;
b) selecting a first logic sentence associated with the first facility;
c) selecting a second facility
d) building a second logic sentence based on the selected first logic sentence adapted to the second facility and associating the second logic sentence with the selected second facility.
   Steps a), b), c) and d) may be repeated to make a number of second logic sentences associated with the second facility.

Typically, the selected first facility and the second facility are of the same type, for example both are pumps. The process construction would involve in this case for example:

The pumps are named Pump A and Pump B. Both have an output named “Operating” and contain another facility—Motor—as a child with output “On”. The first sentence may be: “Pump A reports Operating only while Motor is On”. The second sentence will then be: “Pump B reports Operating only while Motor is On”. In the second sentence, apart from changing the pump name to Pump B, the word Motor refers now to the component (child) of Pump B. When converted to controller code, the reference will be made to the correct component.

Some embodiments comprise prompting of terms while building the second sentence. For example, a pop-up menu display is provided, and a default term is prominently displayed. The default term is provided by matching the current position in a second sentence being made, to an equivalent position in the selected first sentence. However, the user may well select another equivalent term from lists, as described above. For example the lists are presented in the pop-up menu as a scroll-down menu. Alternatively, a different term that is not in the lists is added to the lists and this different term is the term that is selected for the current position in the second sentence.

In some embodiments each of the first sentences is associated with syntax, and the method further comprises automatically verifying that the second sentence complies with the syntax of the matching first sentence. In some embodiments the verifying is on the fly, for example based on the syntax of the selected first sentence, as well as upon the terms selected for the second sentence, as the building proceeds (consecutive selection of terms).

### 3. Model's Data—Restricting Logic to Valid Statements, Extracting Specific Data and Documenting the Model

The construction of sentences is based on the existing variables in the scope of the current node (i.e. the node itself, its children and all their attributes). The defining of sentences is allowed in terms readily used in natural language (human), but the defining is not in free language: no parsing of text is involved. Additionally or alternatively, predefined options are provided, and the editing may comprise selecting from these options. Most actions and conditions can be implemented eventually in the controller code, and in preferred embodiments they are provided as equivalent representations, in sentence-building words. Only valid options are offered: for example, a condition on a Boolean variable can only be checked according to the test whether the variable is set or cleared. A condition on an analog variable is only checked according to the test of greater than/less than another analog value. Another example: if a delay is used, the delay value must be a positive number with units of time.

Some embodiments comprise one or more of the following features:

3.1 Dynamically creating report-lists out of the model: the creating involves labeling entities: nodes and attributes (inputs, outputs, properties, parameters) in the model. Automatically collecting entities labeled with one or more labels selected by the user and, possibly, not labeled with one or more other labels selected by the user yields a list of entities with common characteristics. Such collecting can be very useful to an engineer reviewing the control of the facilities. For example: motors list (all motors in the model), physical I/O list, warnings list etc. The created lists are automatically updated to reflect any relevant change in the model.

3.2 Automatically generating a neutral model document: The model can be represented as a report, showing all the nodes according to the hierarchical tree. The report also shows all the classes (each class including nodes copied from a single template, creating a family of similar nodes) used in the model and the lists derived from the labels given to some nodes or attributes (as explained in item 3.1 above). Most importantly, the logic of each attribute (input, output, property) is presented. Since the logic was defined in a human language, no manual error-prone descriptions are required. It bears repeating that the same logic can be converted to controller code in a deterministic manner, without risking uncertainties, giving full compatibility between the model, the document and the final controller code.

3.3 Interactively documenting the neutral models: Prior to printing it, the report can be presented in a preview display. This display is “alive” and connected to the model using bi-directional links with continuous updating. Some characteristics, like names, descriptions, tag numbers (numerical identifiers of nodes and attributes), document titles and others can be updated directly in the document. The model is updated simultaneously. For other features, which require relatively complex intervention in the model (addition of children, changing levels in the hierarchy), clicking a certain location in the document jumps to the corresponding location in the model.

### 4. Automatic Controller Code Generation

Once a model is constructed, it can be converted to controller code. One principle is to maintain the object-oriented nature of the model and implement it in the controller code, which is usually written in a non-object oriented programming language, e.g. ladder diagram. Some embodiments thus comprise generating code to process a hierarchical data structure, i.e., a tree: the root of the tree (the top node) is associated with a routine to update its properties, to update the inputs of its children, to invoke the routines of its children and to update its outputs. Every child is similarly associated with a routine to perform the same operations for itself. In that way, the generated code processes the entire tree model.

Instead of updating the data structure directly, each routine may receive the part of the data structure that corresponds to its node. That way, one routine may be created for a group of similar facilities, i.e. instances of a class. It is then called multiple times, each call supplies the data of the specific node, i.e. the specific instance.

Every routine corresponds to a facility and contains a conversion of the sentences defined for that facility. Therefore the code is organized, compact and easy to understand, and amenable to validation, in contrast to the code produced by employing some of the commercially available automatic coders in industrial processes. Additionally, the intention of every piece of logic can be understood when looking at the embedded comments or the neutral model or document, where it is provided in words.

Some embodiments comprise one or more of the following features:

4.1 Reusing design models at various hierarchical levels: Every node and its sub-nodes (descendants, if existent) are configured to allow being transformed to a new class. New instances of this class can be used in other locations in the model, and even saved to a library and used in other models. Similarly, predefined models are provided as building blocks for running new processes. Any of these copied models/classes is not a sealed component, but rather a collection of definitions, and can be edited as desired.

4.2 Comparing models and creating “As-Made” document:

Comparing any two models or model components to each other may be performed with the purpose of searching for differences between them.

Additionally, another feature that is provided is comparing controller code to the model: when a model is converted to controller code, the latter can be altered, typically by a control engineer during the commissioning phase of the industrial facility. For documentation purposes and/or other purposes, it is desirable to know which parts of the code (and the equivalent neutral model document) have been changed and which part have not. Detecting the changes comprises: retrieving the final version of the controller code from the controller hardware platform; saving the retrieved code as a file, and comparing this file to the code created based on the existing model. The results are then marked in the model and in a new “As Made” version of the document. The document further allows manually documenting the changes in code.

4.3 Debugging by emulating the model's behavior: The model contains logic, which sometimes can be quite complex. An emulation module is provided that enables the user to run any component of the model and test that it behaves as desired. This includes changing the value of certain component's attributes, repeatedly evaluating the value of all component's attributes, and verifying that the values of certain other attributes are as expected. For example, the user can verify that a filter turns on its output “CleaningRequired” after its input “Operate” is On for a total of one hour.

4.4 Debugging by simulating the process. In general, running the controller code involves receiving inputs from the field (readings of sensors in the process), performing logic depending on these readings and consequently sending updated outputs to the field (e.g. signals to motors, valves and other equipment). The influence of the updated outputs on the process' facilities changes the readings, and so on. Therefore, functionality of the code can only be checked on site once the equipment is connected to it. In order to simulate the response to the controller's outputs, linking of inputs from the field to the controller's outputs to the field is supported. For example, the user may link a water temperature reading (input from field) to an “Operate” command to the water heater (output to field) by defining that the water temperature will increase by 2 degrees per minute while “Operate” command is on. A plurality of links may be applied, similar to the given example.

Once such links are added to the model, the emulation becomes “closed loop”, as if it is executed on-site, thus allowing much more extensive testing of the functionality of the model. Converting these links to code as part of automatic code generation further allows running the code on a controller (or on an emulator of the controller) in the office while it is connected to other systems, mainly Human Machine Interface (HMI) which allows graphical interaction with the control system as will be eventually available to the operators.

4.5 Automatic testing. Multiple pairs of certain changes in some values and their expected resulting behavior may be defined. These pairs may be used to automatically test the control system by sequentially applying the changes of each pair and verifying if the results are as expected.

4.6 Learning from accumulated data: Providing predefined models similar to the one being constructed, based on its structure and names. Although the computer used for the building of the control sentences does not understand the system being modeled, some embodiments provide offering some sentence solutions based on historical accumulated data. When a name of a familiar system is typed (e.g. filter, oil skid, pump) some existing solutions may be offered. Alternatively, when familiar structures are constructed (e.g. two identical pumps in parallel, three sensors measuring the same variable): predefined and tested solutions may be offered.

It is appreciated that certain features of the aspects, which are, for clarity, described in the context of separate embodiments, may also be provided in combination in a single embodiment. Conversely, various features of the invention, which are, for brevity, described in the context of a single embodiment, may also be provided separately or in any suitable sub combination.

Although the aspects have been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A method of generating a neutral control model, for programming at least one production facility controller, using natural language, the method comprising:
enabling a user to define at least one controlled production facility via an interface;
enabling the user to define a plurality of nodes relating to said at least one controlled facility by said interface;
enabling the user to assign to at least one node of the plurality of nodes at least one attribute;
enabling the user to select a plurality of terms from a computer memory repository, from a group comprising of: at least one node; at least one attribute; at least one natural language word; and a combination thereof by said interface;
constructing, for at least one of said attributes, at least one sentence, from said selected terms, based on input received from the user, wherein the at least one sentence defines how a value of the attribute is affected by another value of at least one other attribute;
editing by a processor, each sentence of the at least one sentence, to comply with syntax rules of the neutral control model; and
converting by said processor the at least one sentence into a controller code;
enabling the user to program said at least one production facility controller with said controller code; and
controlling at least one production facility by said at least one production facility controller.

2. The method of claim 1, wherein the neutral control model is formed by the interface in a hierarchical structure tree, and wherein each node of the plurality of nodes is assigned a hierarchical level in the structure tree.

3. The method of claim 1, wherein the at least one attribute is one of: input; output; property; and parameters.

4. The method of claim 1, wherein the interface enables the user to select at least one natural language word from at least one list of words, and wherein at least one attribute is assigned at least one word from the at least one list of words.

5. The method of claim 4, wherein the construction of sentences further comprises automatically prompting by the interface at least one list of words from a plurality of lists of words assigned to the at least one attribute.

6. The method of claim 1, further comprising: deducing by the processor a type of at least one attribute comprised in at least one sentence, according to at least one word in the sentence adjacent to the attribute.

7. The method of claim 5, further comprising: deducing by the processor a type of at least one attribute comprised in a sentence of the at least one sentence according to at least one word in the sentence adjacent to the attribute; and reducing the length of the prompted list of words while constructing the at least one sentence, according to the deduced type of the at least one attribute comprised in the at least one sentence by the processor.

8. The method of claim 6, further comprising: defining, by a user, a type of at least one attribute comprised in at least one sentence; validating, by the processor, the defined type of said attribute by comparing the defined type to the deduced type; and alerting the user if the comparison result indicates a mismatch of types.

9. The method of claim 1, wherein the user is enabled to select a portion of the nodes from a group on the interface, and wherein said group comprises: at least one input having a value set by at least one production facility; at least one output having a value transferred to one of the at least one production facility; a combination thereof; and wherein the user is enabled to link said inputs to said outputs, by defining how the value of each said linked input is affected by the value of said linked outputs.

10. The method of claim 5, wherein the prompted at least one list of words is arranged in a data structure, and stored within a computer memory repository, and wherein said data structure is dynamic in size, and wherein the user is enabled to add at least one additional word of his choice to said data structure of prompted at least one list of words.

11. The method of claim 1, wherein a portion of the words of the list of words from the plurality of lists of words have similar logical meaning.

12. The method of claim 1, wherein the controller code is ported to a computerized device, and wherein said computerized device is configured to enable debugging of the controller code prior to operating the production facility.

13. The method of claim 12, wherein each attribute comprises a value, and wherein the debugging comprises:
setting predetermined values to at least one attributes of a first portion of the plurality of nodes;
obtaining values of at least one attributes of a second portion of the plurality of nodes;
comparing expected values of at least one attributes of a second portion of the plurality of nodes with obtained values of at least one attributes of a second portion of the plurality of nodes; and
outputting an alert in case of a mismatch between the expected and obtained values.

14. The method of claim 1, wherein the method further comprises enabling the user to:
select a first production facility from said at least one of defined production facilities;
select a first sentence associated with said first production facility;
select a second production facility from said at least one of defined production facilities; and
construct a second sentence based on the selected first sentence adapted to the second production facility and associating the second sentence with the selected second production facility.

15. The method of claim 14, wherein the first sentence is associated with syntax rules, and wherein the method further comprises automatically verifying that the second sentence complies with the syntax rules of the matching first sentence.

16. The method of claim 1, wherein the at least one sentence is understandable by a human reader and is unambiguously convertible to controller code.

17. The method of claim 1, further comprising automatically checking by a processor, that at least one sentence is associated with an attribute, and wherein the at least one sentence completely defines the value of the attribute.

18. The method of claim 17, wherein if the value of the attribute is not completely logically defined by a group of sentences comprising at least one sentence, the processor produces at least one additional, complementary sentence, so as to complete the logic definition of the attribute by said group of sentences and the additional sentence; and wherein the processor is further configured to mark sentences that are redundant in relation to logic completeness, and need to be deleted.

19. The method of claim 1, further comprising:
enabling the user to label with at least one distinctive label each of a first portion of the plurality of nodes;
enabling the user to label with at least one distinctive label each of a second portion of attributes of the plurality of nodes; and
displaying by the interface a list of nodes and attributes labeled by said distinctive labels, and/or not labeled by said labels, excluding the at least one distinctive label.

20. A method of defining relations between a plurality of objects representing a controlled system, the method comprising:
enabling a user to provide a hierarchical structure of the plurality of objects by an interface;
enabling the user to provide a name and interface signals for at least one of the plurality of objects by the interface;
associating each of the plurality of objects with a portion of other objects to create groups of objects;
providing a partial formal grammar, comprising a set of rules to define possible relations among objects in any group, wherein the relations express exchange and manipulation of interface signals among the objects in the group over time;
for each group, completing the partial formal grammar by adding rules that allow derivation of the objects in the group and their interface signals to create a formal grammar which defines the possible relations among objects in the group;
constructing a textual sentence for at least one interface signal of the at least one object in each group, wherein the textual sentence is valid according to the formal grammar;
constructing additional sentences until the value of each interface signal is completely defined at any time;
automatically converting the hierarchical structure and the textual sentences by a processor to code, loaded into a computerized device that is wired to receive at least one input from and/or deliver at least one output to an object of the controlled system; and
controlling said object of the controlled system by said computerized device.
